(19) United States
(12) Patent Application Publication
(10) Pub. No.: US 2021/0233063 A1
(43) Pub. Date: Jul. 29, 2021

(54) SERVER AND METHOD FOR VALUE TRANSFER CARD REPLACEMENT

(71) Applicant: The Toronto-Dominion Bank, Toronto (CA)

(72) Inventor: Ravi Vasant ACHARYA, Philadelphia, PA (US)

(73) Assignee: The Toronto-Dominion Bank, Toronto (CA)

(21) Appl. No.: 16/751,789

(22) Filed: Jan. 24, 2020

(51) Int. Cl. G06Q 20/34; G06F 3/12; G06Q 20/36; G06Q 20/40

(52) U.S. Cl. CPC G06Q 20/354; G06F 3/1204; G06Q 20/4016; G06F 3/1254; G06Q 20/367; G06F 3/1243

(57) ABSTRACT

A server comprises a communications module, a processor coupled to the communications module, and a memory coupled to the processor, the memory storing processor-executable instructions which, when executed by the processor, configure the processor to receive, via the communications module and from a client device, an indication that a physical value transfer card has been compromised in response to receiving the indication that the physical value transfer card has been compromised, provide, via the communications module and to the client device, a selectable option to add a digital value transfer card to a mobile wallet application associated with the client device, receive, via the communications module and from the client device, an indication of a selection of the selectable option to add the digital value transfer card to the mobile wallet application associated with the client device, and provision the mobile wallet application associated with the client device with the digital value transfer card.

### TECHNICAL FIELD

The present application relates to value transfer cards and, more particularly, to servers and methods for value transfer card replacement.

### BACKGROUND

When a physical value transfer card is reported lost or stolen, the physical value transfer card is cancelled. When the physical value transfer card is cancelled, the owner or user of the physical value transfer card may be left without means for payment.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computing device;

FIG. 4 shows a simplified organization of software components stored in a memory of the example computing device of FIG. 3;

FIG. 5 is a flowchart showing operations performed by a server in value transfer card replacement;

FIGS. 6A and 6B are example screens of a graphical user interface;

FIGS. 7A to 7C are example screens of a graphical user interface;

FIG. 8 is a flowchart showing operations performed by a server for generating a replacement physical value transfer card;

FIGS. 9A and 9B are example screens of a graphical user interface;

FIG. 10 is an example screen of a graphical user interface;

FIG. 11 is an example screen of a graphical user interface; and

FIG. 12 is an example screen of a graphical user interface.

Like reference numerals are used in the drawings to denote like elements and features.

### DETAILED DESCRIPTION OF VARIOUS EMBODIMENTS

Accordingly, in one aspect there is provided a server comprising a communications module; a processor coupled to the communications module; and a memory coupled to the processor, the memory storing processor-executable instructions which, when executed by the processor, configure the processor to receive, via the communications module and from a client device, an indication that a physical value transfer card has been compromised; in response to receiving the indication that the physical value transfer card has been compromised, provide, via the communications module and to the client device, a selectable option to add a digital value transfer card to a mobile wallet application associated with the client device; receive, via the communications module and from the client device, an indication of a selection of the selectable option to add the digital value transfer card to the mobile wallet application associated with the client device; and provision the mobile wallet application associated with the client device with the digital value transfer card.

In one or more embodiments, the processor-executable instructions, when executed by the processor, further configure the processor to detect an indication of fraud associated with the physical value transfer card; and send, via the communications module and to the client device, a notification of possible fraud; wherein the indication that the physical value transfer card has been compromised is received in response to the notification of the possible fraud.

In one or more embodiments, the indication of fraud is detected based at least on electronic data of one or more payments made using the physical value transfer card.

In one or more embodiments, the electronic data includes at least one of a location of a payment, an amount of the payment and a frequency of the payment.

In one or more embodiments, the processor-executable instructions, when executed by the processor, further configure the processor to obtain, via the communications module and from the client device, location data representing a location of the client device; identify, from a database, an electronic address associated with a nearest branch to the client device; and send, via the communications module and to the electronic address, an electronic message configuring a printer to automatically generate a replacement physical value transfer card.

In one or more embodiments, the printer is an embosser.

In one or more embodiments, the processor-executable instructions, when executed by the processor, further configure the processor to send, via the communications module and to the client device, an indication that the replacement physical value transfer card is available for pick up.

In one or more embodiments, the processor-executable instructions, when executed by the processor, further configure the processor to send, via the communications module and to the client device, instructions for picking up the replacement physical value transfer card.

In one or more embodiments, the indication that the physical value transfer card has been compromised includes an indication that the physical value transfer card has been lost or stolen.

In one or more embodiments, the indication that the physical value transfer card has been compromised is received, via the communications module and from the client device, in response to user selection of a lock card function.

In another aspect there is provided a method comprising receiving, via a communications module and from a client device, an indication that a physical value transfer card has been compromised; in response to receiving the indication that the physical value transfer card has been compromised, providing, via the communications module and to the client device, a selectable option to add a digital value transfer card to a mobile wallet application associated with the client device; receiving, via the communications module and from the client device, an indication of a selection of the selectable option to add the digital value transfer card to the mobile wallet application associated with the client device; and provisioning the mobile wallet application associated with the client device with the digital value transfer card.

In one or more embodiments, the method further comprises detecting an indication of fraud associated with the physical value transfer card; and sending, via the communications module and to the client device, a notification of possible fraud; wherein the indication that the physical value transfer card has been compromised is received in response to the notification of the possible fraud.

In one or more embodiments, the indication of fraud is detected based at least on electronic data of one or more payments made using the physical value transfer card.

In one or more embodiments, the electronic data includes at least one of a location of a payment, an amount of the payment and a frequency of the payment.

In one or more embodiments, the method further comprises obtaining, via the communications module and from the client device, location data representing a location of the client device; identifying, from a database, an electronic address associated with a nearest branch to the client device; and sending, via the communications module and to the electronic address, an electronic message configuring a printer to automatically generate a replacement physical value transfer card.

In one or more embodiments, the method further comprises sending, via the communications module and to the client device, an indication that the replacement physical value transfer card is available for pick up.

In one or more embodiments, the method further comprises sending, via the communications module and to the client device, instructions for picking up the replacement physical value transfer card.

In one or more embodiments, the indication that the physical value transfer card has been compromised includes an indication that the physical value transfer card has been lost or stolen.

In one or more embodiments, the indication that the physical value transfer card has been compromised is received, via the communications module and from the client device, in response to user selection of a lock card function.

In another aspect there is provided a non-transitory computer readable storage medium comprising computer-executable instructions which, when executed, configure a computing device to receive, via a communications module and from a client device, an indication that a physical value transfer card has been compromised; in response to receiving the indication that the physical value transfer card has been compromised, provide, via the communications module and to the client device, a selectable option to add a digital value transfer card to a mobile wallet application associated with the client device; receive, via the communications module and from the client device, an indication of a selection of the selectable option to add the digital value transfer card to the mobile wallet application associated with the client device; and provision the mobile wallet application associated with the client device with the digital value transfer card.

Systems and methods for value transfer card replacement are described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the following, value transfer cards are described. Value transfer cards may be credit cards or debit cards. Value transfer cards may be physical value transfer cards or digital value transfer cards. Physical value transfer cards may be an ISO/IEC 7810 format card. Digital value transfer cards may be stored in a mobile wallet associated with a client device.

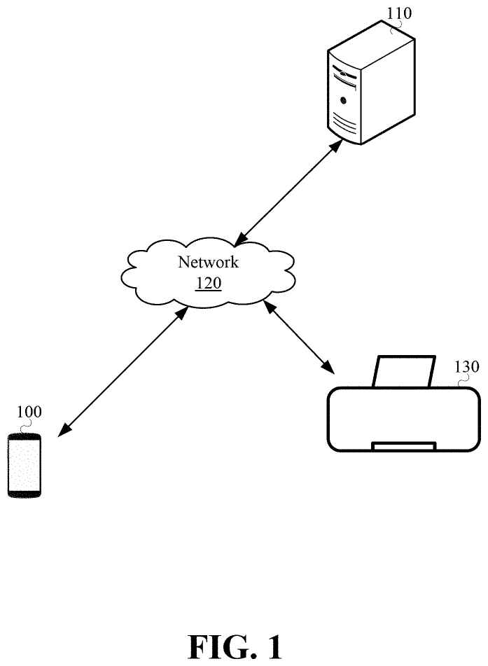

FIG. 1 is a schematic operation diagram illustrating an operating environment of an example embodiment.

As illustrated, a client device 100 and a server 110 communicate via a network 120. A printer 130 may also communicate with the client device 100 and the server 110 over the network 120.

The client device 100, the server 110 and the printer 130 may be in geographically disparate locations. Put differently, the client device 100, the server 110 and the printer 130 may be located remote from one another.

The client device 100 and the server 110 are computer systems. The client device 100 may take a variety of forms including, for example, a mobile communication device such as a smartphone, a tablet computer, a wearable computer such as a head-mounted display or smartwatch, a laptop or desktop computer, or a computing device of another type.

The printer 130 may be located within a branch of a bank and may comprise an internal computer system (not shown) that is configured to communicate with the client device 100 and/or server 110 over the network 120. The printer 130 may include an embossing function configured to emboss a value transfer card. The printer 130 may additionally or alternatively include a printing function configured to print on a value transfer card.

The client device 100 is adapted to present a graphical user interface that allows for communication with the server 110. For example, the client device 100 may be adapted to prompt a user to respond to queries communicated from the server 110. The client device 100 may be adapted to submit a request for a replacement value transfer card through a chat interface and/or mobile application that may be provided on the client device 100. The client device 100 may be adapted to receive and/or store a digital value transfer card associated with an account stored on the server 110.

As will be described in more detail below, the server 110 is adapted to generate and provide a digital value transfer card associated with an account to the client device 100 in response to receiving an indication that a physical value transfer card has been compromised, lost or stolen. The server 110 may receive location data indicating a location of the client device 100, may determine a nearest branch to the client device 100, and may automatically communicate with a printer located at the nearest branch to automatically generate a replacement physical value transfer card. Operations associated with the server 110 will be described in greater detail below.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, a telecommunications network or the like.

As further explained below, the client device 100 communicates with the server 110 via the network 120 to generate a replacement physical value transfer card and/or to obtain a digital value transfer card in the event that a physical value transfer card is compromised, lost or stolen. In at least some embodiments, the server 110 and the printer 130 may automatically generate a replacement digital value transfer card based on a location of the client device 100 without any human intervention.

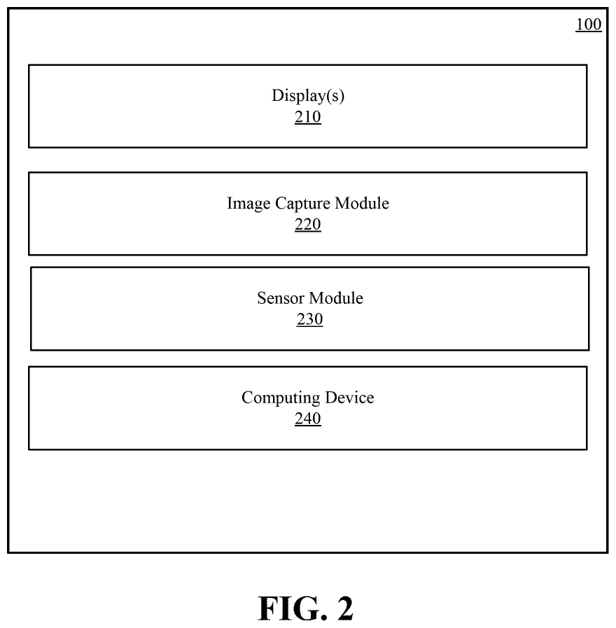

FIG. 2 is a simplified schematic diagram showing components of the client device 100.

The client device 100 may include modules including, as illustrated, for example, one or more displays 210, an image capture module 220, a sensor module 230, and a computing device 240.

The one or more displays 210 are a display module. The one or more displays 210 are used to display screens of a graphical user interface that may be used, for example, to indicate that a value transfer card has been compromised (FIG. 1). The one or more displays 210 may be internal displays of the client device 100 (e.g., disposed within a body of the client device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the client device 100. The location may be the current geographic location of the client device 100. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computing device 240 is in communication with the one or more displays 210, the image capture module 220, and the sensor module 230. The computing device 240 may be or may include a processor which is coupled to the one or more displays 210, the image capture module 220, and/or the sensor module 230.

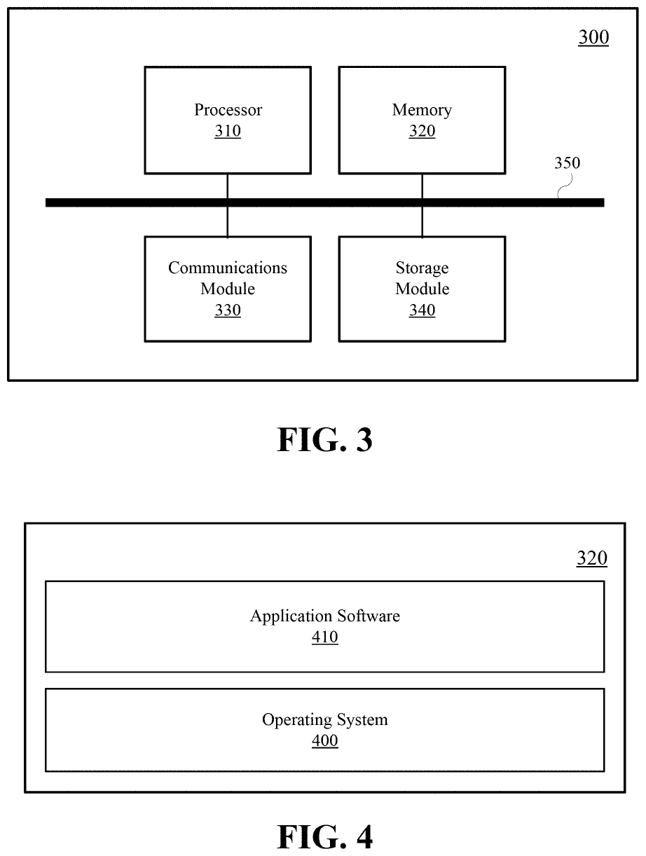

FIG. 3 is a high-level operation diagram of an example computing device 300. In some embodiments, the example computing device 300 may be exemplary of the computing device 240 (FIG. 2) and/or the server 110 (FIG. 1) and/or the internal computer system of the printer 130 (FIG. 1).

The example computing device 300 includes a variety of modules. For example, as illustrated, the example computing device 300 may include a processor 310, a memory 320, a communications module 330, and/or a storage module 340. As illustrated, the foregoing example modules of the example computing device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 300.

The communications module 330 allows the example computing device 300 to communicate with other computing devices and/or various communications networks. For example, the communications module 330 may allow the example computing device 300 to send or receive communications signals. Communications signals may be sent or received according to one or more protocols or according to one or more standards. For example, the communications module 330 may allow the example computing device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing device 300 to communicate using near-field communication (NFC), via Wi-Fi™, using Bluetooth™ or via some combination of one or more networks or protocols. In some embodiments, all or a portion of the communications module 330 may be integrated into a component of the example computing device 300. For example, the communications module may be integrated into a communications chipset. In some embodiments, the communications module 330 may be omitted such as, for example, if sending and receiving communications is not required in a particular application.

The storage module 340 allows the example computing device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computing device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computing device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing device 300, in combination with the operating system 400, to operate as a device performing a particular function. For example, the application 410 may cooperate with the operating system 400 to adapt a suitable embodiment of the example computing device 300 to operate as the computing device 240 (FIG. 2) of the client device 100 (FIG. 1) and/or the server 110 (FIG. 1) and/or the internal computer system of the printer 130 (FIG. 1).

Where the application 410 is provided on the client device 100, the application may be a mobile banking application associated with an account. The application 410 may be a web-based or standalone application. The application 410 may be configured to engage in an authenticated session with the server 110. The authenticated session may occur, for example, after the client device 100 has validly authenticated itself to the server 110 using, for example, one or more credentials. During the authenticated session, the client device 100 may engage in encrypted communications with the server 110. For example, as will be described in detail below, the client device 100 may send location data to the server 110 and the server 110 may analyze the location data to determine a nearest branch to the client device 100. The application may additionally or alternatively be a mobile wallet application that is stored in memory on the client device 100 and includes value transfer card information. The mobile wallet application may utilize an NFC module of the client device 100 to make in-store payments and may additionally be used to make online payments.

Where the application 410 is provided on the server 110, the application 410 may include a plurality of software modules associated with mobile banking. For example, a credit module may include computer-executable instructions for determining an amount of credit available to a particular account, a fraud detection module may include computer-executable instructions for identifying potential fraudulent activity on a particular account, a value transfer card management module may include computer-executable instructions for cancelling or locking a value transfer card based on output from the fraud detection module, a value transfer card replacement module may include computer-executable instructions for determining a nearest branch location based on location data received from the client device 100 and for communicating electronic data to the printer 130 at the nearest branch location to generate a replacement physical value transfer card.

Where the application 410 is provided as part of the internal computing system of the printer 130, the application 410 may include one or more modules associated with printing or embossing a credit card. For example, a printing module may include computer-executable instructions for printing or embossing a value transfer card number on a blank or new value transfer card based on electronic data received from the server 110.

At least some components illustrated in FIG. 3 or FIG. 4 may take different forms depending on which of the computing devices they are provided on. For example, a server 110 may include or have access to a storage module 340 (which may also be referred to as a data store) which has stored thereon profiles for a plurality of accounts, who may be associated with a user or customer. Each account may include account data such as transaction data, credit data, bank data, user data, value transfer card data, etc. The transaction data may specify information associated with spending on a particular value transfer card. For example, each charge on the value transfer card may be stored as transaction data and may include information such as an amount of the charge, a date of the charge, a time of the charge and a place of the charge. The credit data may specify a maximum amount of credit available to the user, an amount of used credit by the user, and amount of remaining credit available to the user. The bank data may specify an amount of funds stored in the user's account which may be a chequing account and/or a savings account. The user data may include a user's first and last name, address, birthdate, account number(s), etc. The value transfer card data may include a list of value transfer cards issued to the user and may include, for each value transfer card, a type (e.g. physical credit card, virtual credit card, physical debit card, virtual debit card), a value transfer card number (e.g. a credit card number, an expiry date, etc.), security information (e.g. a pin number), etc.

Operations performed by the client device 100, the server 110 and the printer 130 will now be described.

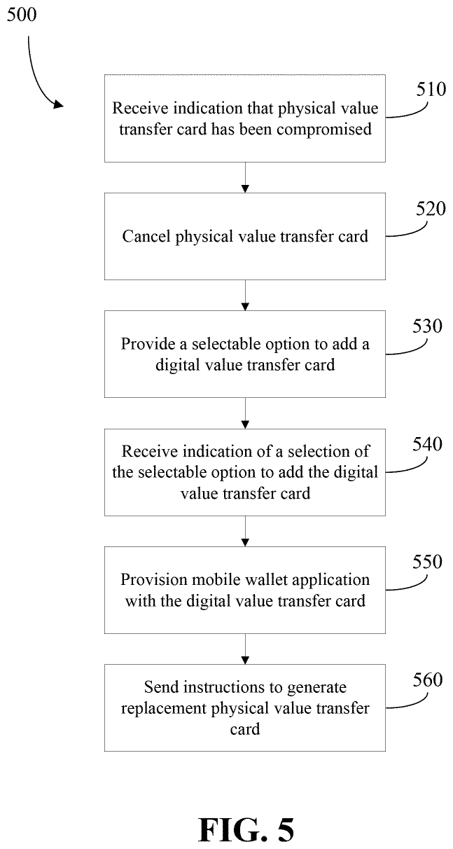

FIG. 5 is a flowchart showing a method 500 for value transfer card replacement. The operations in method 500 are performed by server 110. More specifically, computer-executable instructions stored in memory of the server 110 may, when executed by a processor of the server 110, configure the server 110 to perform the method 500 or a portion thereof.

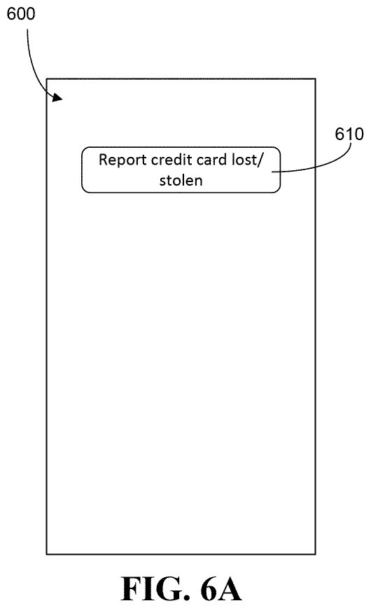

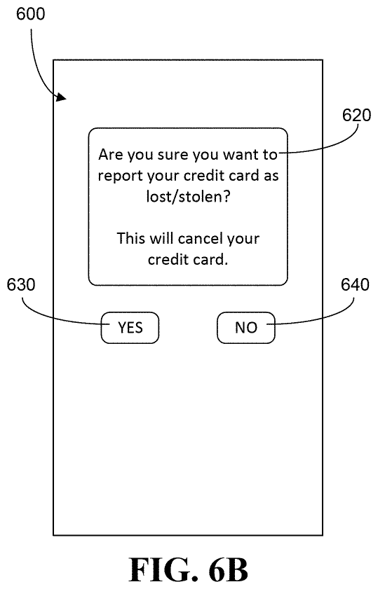

Method 500 begins when the server 110 receives, via the communications module and from the client device 100, an indication that a physical value transfer card has been compromised (step 510). In this embodiment, the indication is received in response to a user reporting the physical value transfer card is lost or stolen through a mobile application stored on the client device 100. An example is shown in FIGS. 6A and 6B. As can be seen, within the mobile application, a graphical user interface (GUI) 600 is displayed on the client device 100. The GUI 600 allows for manipulation of one or more selectable options via an input interface (such as a touchscreen) associated with the client device 100. Touch gestures, for example, may be used to select the one or more selectable options. In the example shown in FIG. 6A, the GUI 600 includes a selectable option 610 which, when selected by the user, reports a physical value transfer card as lost or stolen. In response to the selectable option 610 being selected by the user, within the GUI 600, the mobile application may display a message 620 (shown in FIG. 6B) asking the user to confirm that they would like to report their physical value transfer card as lost or stolen. Along with the message 620, the mobile application may provide selectable options 630 and 640 which, when selected by the user, confirms or denies that they would like to report their physical value transfer card as lost or stolen, respectively. Once the user selects the selectable option 630 to confirm that they would like to report their physical value transfer card as lost or stolen, an indication that the physical value transfer card is lost or stolen is communicated to the server 110. The indication may include user data that provides the server 110 with user information such as for example the user's first and last name, account number, etc. and may include value transfer card data that provides the server 110 with physical value transfer card information such as for example the type of physical value transfer card (debit or credit), the physical value transfer card number, etc.

Once the server 110 receives the indication that the physical value transfer card is lost or stolen, the physical value transfer card is cancelled (step 520). In this embodiment, the server 110 updates the value transfer card data to indicate that the physical value transfer card is cancelled and can no longer be used. As such, should someone try to use the physical value transfer card for a transaction, the transaction will be denied.

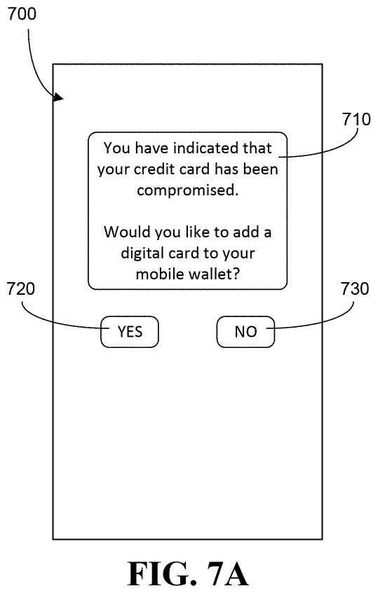

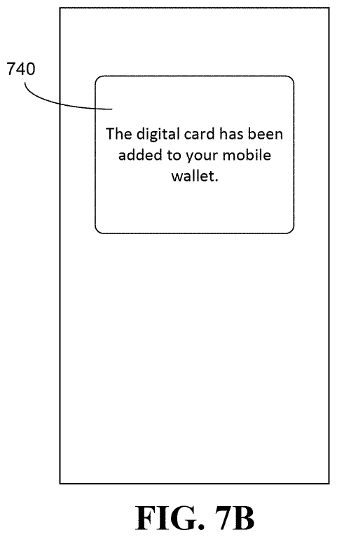

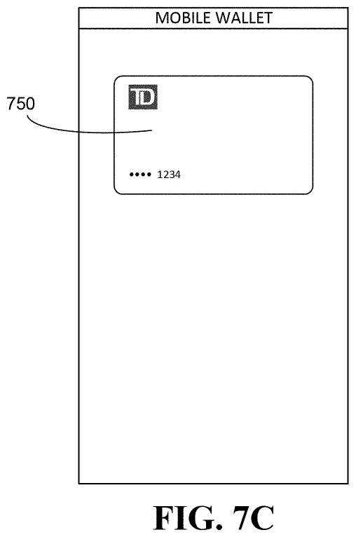

The server 110 provides, via the communications module and to the client device 100, a selectable option to add a digital value transfer card to a mobile wallet application on the client device 100 (step 530). In this embodiment, the selectable option is presented to the user through a GUI 700 shown in FIG. 7A. The GUI 700 may be presented through the mobile application. The GUI 700 includes a message 710 asking the user if they would like to add a digital value replacement card to their mobile wallet. Along with the message 710, selectable options 720 and 720 are provided to the user which, when selected by the user, confirms or denies that the user would like to add the digital replacement card to their mobile wallet, respectively.

The server 110 receives, via the communications module and from the client device 100, the indication of a selection of the selectable option to add the digital value transfer card to the mobile wallet application on the client device 100 (step 540). In this embodiment, once the user selects the selectable option 720 confirming that the user would like to add a digital value replacement card to their mobile wallet, an indication of the selection is communicated from the client device 100 to the server 110.

The server 110 provisions the mobile wallet application of the client device 100 with the digital value transfer card (step 550). In this embodiment, the server 110 generates a new digital value transfer card by generating new value transfer card data that includes the type of value transfer card (digital credit or digital debit) and the digital value transfer card number and associating the value transfer card data with the user. The digital value transfer card data is communicated, via the communications module, to the client device 100. Once the digital value transfer card data is received by the client device 100, the client device 100 may display a message 740 to the user indicating that the digital value transfer card has been added to the mobile wallet, as shown in FIG. 7B.

An exemplary digital value transfer card 750 is shown in FIG. 7C. The digital value transfer card 750 may be accessed by the user by selecting or opening a mobile wallet application or a mobile banking application on the client device 100. The digital value transfer card 750 may be used along with an NFC module of the client device 100 to make in-store payments and may additionally be used to make online payments. In some instances, the digital value transfer card 750 may only be accessed by the user once the client device 100 has been unlocked using a passcode, a fingerprint scan, a retinal scan, or other known methods. In some instances, the digital value transfer card 750 may be accessed through applications such as for example Apple Pay™, Google Pay™, etc. As will be appreciated, the digital value transfer card may be provisioned to the mobile wallet application almost immediately after the physical value transfer card has been indicated as compromised.

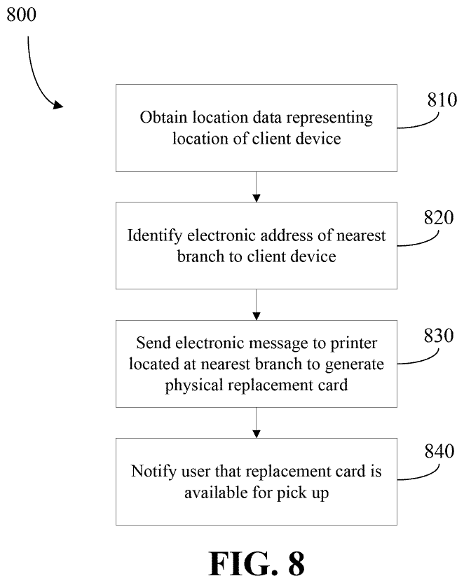

The server 110 sends, via the communications module and to the printer 130, instructions to generate a replacement physical value transfer card (step 560). In this embodiment, once the physical value transfer card has been cancelled, the server 110 sends instructions to generate a replacement physical value transfer card according to a method 800 shown in FIG. 8. The replacement physical value transfer card may be generated almost immediately after the physical value transfer card has been indicated as compromised.

The server 110 receives, via the communications module and from the client device 100, location data representing the location of the client device 100 (step 810). In this embodiment, the location data may be generated by the sensor module 230 of the client device 100.

The server 110 identifies the nearest branch to the client device 100 and identifies an electronic address associated with a printer located at that branch (step 820). In this embodiment, the server 110 accesses a database listing all available branches and determines the nearest branch to the location of the client device 100. The server 110 then accesses, from the database, the electronic address of a printer located at that branch.

The server 110 communicates, via the communications module and to the printer located at the nearest branch, an electronic message to generate the replacement physical value transfer card (step 830). In this embodiment, the electronic message includes value transfer card data including the value transfer card number and the user's name.

In response to receiving the electronic message, the printer 130 prints or embosses the replacement physical value transfer card. The replacement physical value transfer card number may be generated on a blank value transfer card made of metal or plastic. For example, the blank value transfer card may be made of metal and as such the printer 130 may be configured to print the replacement physical value transfer card number on a surface of the blank value transfer card. As another example, the blank value transfer card may be made of plastic and as such the printer may be configured to emboss the replacement physical value transfer card number on a surface of the blank value transfer card.

Once the printer 130 has completed generating the replacement physical value transfer card, the printer 130 communicates a message to the server 110 indicating that the replacement physical value transfer card is available for pick up. In response, the server 110 sends, via the communications module and to the client device 100, a notification indicating that the replacement value transfer card is available for pick up (step 840).

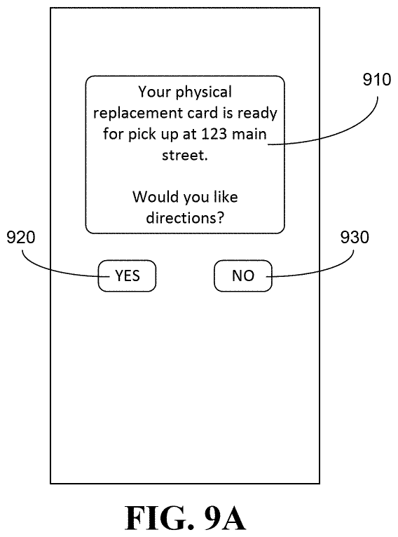

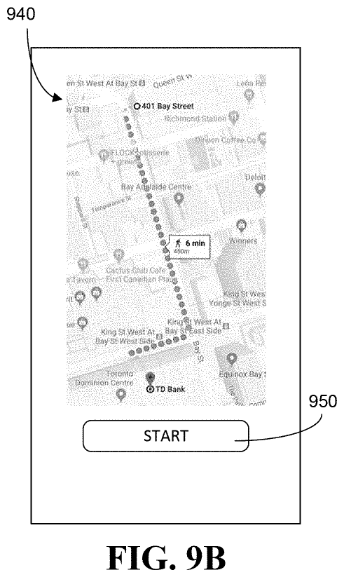

In this embodiment, as shown in FIG. 9A, the notification displays a message 910 to the user on the client device 100. Along with the message 910, selectable options 920 and 930 are provided which, when selected by the user, confirms or denies that they would like directions to pick up the replacement physical value transfer card, respectively. Once the user selects the selectable option 920 to confirm that they would like directions to pick up the replacement physical value transfer card, a map 940 may be displayed to the user as shown in FIG. 9B. The map 940 may be generated by the server 110 and may provide directions based on location data received from the client device 100 and based on the address of the branch that generated the replacement physical value transfer card. The map 940 may include a time and/or a distance to the branch. The map 940 may include options such as driving directions or walking directions. The map 940 includes a selectable option 950 which, when selected by the user, provides step by step directions to the user. The step by step directions may be continuously updated as the location of the client device 100 changes. The step by step directions may include directions such as “turn left”, “turn right”, etc. and may include additional information such as measurements. For example, the step by step directions may include directions and measurements such as “in 900 meters, turn left.” The measurements may update as the location of the client device 100 changes. As will be appreciated, the map 940 may alternatively be generated by the client device 100.

Although in embodiments, the indication that the physical value transfer card has been compromised is described as being received in response to the user reporting that the physical value transfer card is lost or stolen through a mobile application, those skilled in the art will appreciate that alternatives are available. For example, in another embodiment the server 110 may continuously monitor transactions made on the physical value transfer card to detect potential fraudulent activity. Signs of potential fraudulent activity may be an amount spent at a particular vendor or website, abnormal spending patterns, a distance between concurrent transactions, if the physical value transfer card was used at a location known to be high risk, etc.

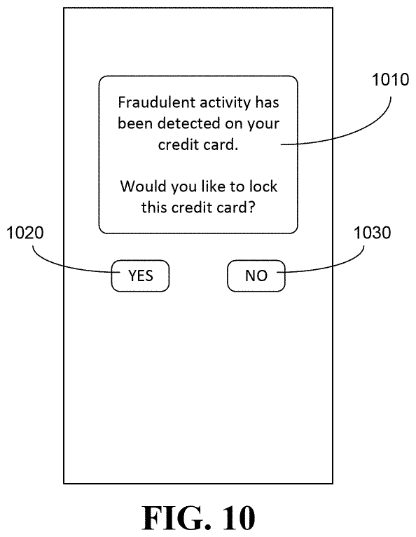

An example is shown in FIG. 10. In this example, the server 110 continuously monitors transactions made on the physical value transfer card to detect potential fraudulent activity. In the event that fraudulent activity is detected, the server 110 may send, via the communications module, a notification to the client device 100 indicating that fraudulent activity has been detected. The notification may be in the form of a message 1010 displayed to the user. Along with the message 1010, selectable options 1020 and 1030 are provided which, when selected by the user, confirms or denies that they would like to lock or cancel the physical value transfer card, respectively. When the user selects the selectable option 1020, indication that the physical value transfer card has been compromised is communicated from the client device 100 to the server 110 and the physical value transfer card may be locked or cancelled in a manner similar to that described above. It will be appreciated that the example shown in FIG. 10 may be used with method 500, specifically during steps 510 and 520.

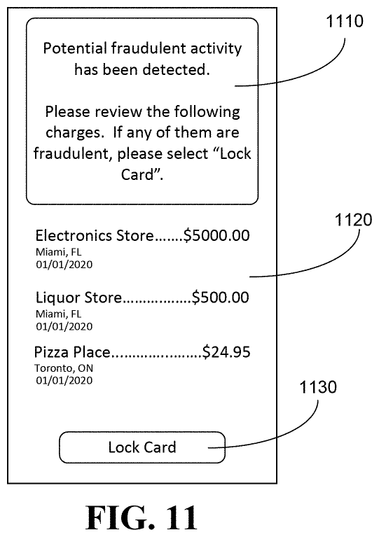

Another example is shown in FIG. 11. In this example, the server 110 continuously monitors transactions made on the physical value transfer card to detect potential fraudulent activity. In the event that fraudulent activity is detected, the server 110 may send, via the communications module, a notification to the client device 100 indicating that potential fraudulent activity has been detected. The notification may be in the form of a message 1110 displayed to the user. Along with the message 1110, the server 110 may send, to the client device 100, transaction data 1120 listing the most recent transactions made on the physical value transfer card. In the example shown in FIG. 11, potential fraudulent activity is detected due to the fact that, on Jan. 1, 2020, two transactions were made in Miami, Fla. and a third transaction was made in Toronto ON. The message 1010 may ask the user to review the transaction data 1120 to confirm that one or more of the transactions are fraudulent. A selectable option 1130 may be provided to the user which, when selected, may indicate to the server 110 that the physical value transfer card has been compromised and the physical value transfer card may be locked or cancelled in a manner similar to that described above. It will be appreciated that the example shown in FIG. 11 may be used with method 500, specifically during steps 510 and 520.

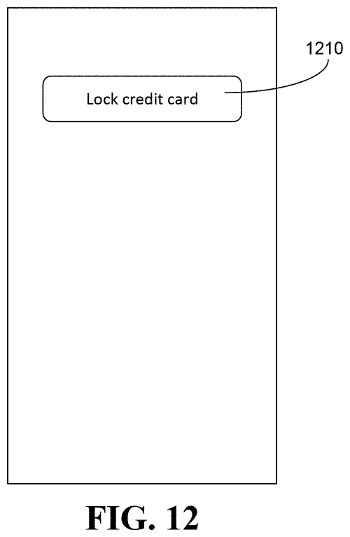

Another example is shown in FIG. 12. In this example, the mobile application on the client device 100 may include a selectable option 1210 that, when selected by the user, communicates to the server 110 an indication that the physical value transfer card has been compromised and the physical value transfer card may be locked or cancelled in a manner similar to that described above. The example shown in FIG. 12 may be used to lock the physical value transfer card as desired by the user, for example in the event that the user loses the physical value transfer card. It will be appreciated that the example shown in FIG. 12 may be used with method 500, specifically during steps 510 and 520.

Although in embodiments described above the replacement physical value transfer card is described as being generated at the branch nearest to the location of the client device, those skilled in the art will appreciate that alternatives are available. For example, in another embodiment the replacement physical value transfer card may be generated at the branch nearest to the user's home or office. In another embodiment, the replacement physical value transfer card may be generated at a branch selected by the user. In another embodiment, the replacement physical value transfer card may be generated by a printer located outside of a branch. In another embodiment, the replacement physical value transfer card may be delivered to the user or dropped off at a particular location selected by the user.

As will be appreciated, at least some of the above embodiments and examples may be implemented within a mobile application installed on the client device. The mobile application may include other features some of which may be based on the geographical location of the client device.

The methods described above may be modified and/or operations of such methods combined to provide other methods.

Furthermore, the description above generally describes operations that may be performed by a server and a client device in cooperation with one another. Operations that are described as being performed by the server may, instead, be performed by the client device.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A server comprising:
a communications module;
a processor coupled to the communications module; and
a memory coupled to the processor, the memory storing processor-executable instructions which, when executed by the processor, configure the processor to:
detect potentially fraudulent activity associated with a physical value transfer card based on at least one recent payment made using the physical value transfer card;
send, via the communications module and to a client device, a signal including a notification of potential fraud, electronic data listing the at least one recent payment made using the physical value transfer card, and a selectable option to confirm fraud and lock the physical value transfer card;
receive, via the communications module and from the client device, an indication of a selection of the selectable option to confirm fraud and lock the that a physical value transfer card;
in response to receiving the signal indicating selection of the selectable option to confirm fraud and lock the physical value transfer card, provide, via the communications module and to the client device, a selectable option to add a digital value transfer card to a mobile wallet application associated with the client device;
receive, via the communications module and from the client device, an indication of a selection of the selectable option to add the digital value transfer card to the mobile wallet application associated with the client device; and
provision the mobile wallet application associated with the client device with the digital value transfer card.

2. (canceled)

3. (canceled)

4. The server of claim 1, wherein the electronic data includes at least one of a location of a payment, an amount of the payment and a frequency of the payment.

5. The server of claim 1, wherein the processor-executable instructions, when executed by the processor, further configure the processor to:
obtain, via the communications module and from the client device, location data representing a location of the client device;
identify, from a database, an electronic address associated with a nearest branch to the client device; and
send, via the communications module and to the electronic address, an electronic message configuring a printer to automatically generate a replacement physical value transfer card.

6. The server of claim 5, wherein the printer is an embosser.

7. The server of claim 5, wherein the processor-executable instructions, when executed by the processor, further configure the processor to:
send, via the communications module and to the client device, an indication that the replacement physical value transfer card is available for pick up.

8. The server of claim 7, wherein the processor-executable instructions, when executed by the processor, further configure the processor to:
send, via the communications module and to the client device, instructions for picking up the replacement physical value transfer card.

9. (canceled)

10. (canceled)

11. A method comprising:
detecting potentially fraudulent activity associated with a physical value transfer card based on at least one recent payment made using the physical value transfer card;
sending, via a communications module and to a client device, a signal including a notification of potential fraud, electronic data listing the at least one recent payment made using the physical value transfer card, and a selectable option to confirm fraud and lock the physical value transfer card;
receiving, via the communications module and from the client device, an indication of a selection of the selectable option to confirm fraud and lock the physical value transfer card;
in response to receiving the signal indicating selection of the selectable option to confirm fraud and lock the physical value transfer card, providing, via the communications module and to the client device, a selectable option to add a digital value transfer card to a mobile wallet application associated with the client device;
receiving, via the communications module and from the client device, an indication of a selection of the selectable option to add the digital value transfer card to the mobile wallet application associated with the client device; and
provisioning the mobile wallet application associated with the client device with the digital value transfer card.

12. (canceled)

13. (canceled)

14. The method of claim 11, wherein the electronic data includes at least one of a location of a payment, an amount of the payment and a frequency of the payment.

15. The method of claim 11, further comprising:
obtaining, via the communications module and from the client device, location data representing a location of the client device;
identifying, from a database, an electronic address associated with a nearest branch to the client device; and
sending, via the communications module and to the electronic address, an electronic message configuring a printer to automatically generate a replacement physical value transfer card.

16. The method of claim 15, further comprising:
sending, via the communications module and to the client device, an indication that the replacement physical value transfer card is available for pick up.

17. The method of claim 16, further comprising:
sending, via the communications module and to the client device, instructions for picking up the replacement physical value transfer card.

18. (canceled)

19. (canceled)

20. A non-transitory computer readable storage medium comprising computer-executable instructions which, when executed, configure a computing device to:
detect potentially fraudulent activity associated with a physical value transfer card based on at least one recent payment made using the physical value transfer card;
send, via a communications module and to a client device, a signal including a notification of potential fraud, electronic data listing the at least one recent payment made using the physical value transfer card, and a selectable option to confirm fraud and lock the physical value transfer card;
receive, via the communications module and from the client device, an indication of a selection of the selectable option to confirm fraud and lock the physical value transfer card;
in response to receiving the signal indicating selection of the selectable option to confirm fraud and lock the physical value transfer card, provide, via the communications module and to the client device, a selectable option to add a digital value transfer card to a mobile wallet application associated with the client device;
receive, via the communications module and from the client device, an indication of a selection of the selectable option to add the digital value transfer card to the mobile wallet application associated with the client device; and
provision the mobile wallet application associated with the client device with the digital value transfer card.

21. The system of claim 1, wherein detecting potentially fraudulent activity associated with the physical transfer card based on the at least one recent payment made using the physical value transfer card includes at least one of:
determining that an amount spent at a particular vendor or website is greater than a threshold;
identifying abnormal spending patterns;
determining that a distance between two or more recent payments is greater than a threshold; or
determining that the physical transfer card was used at a location known to be high risk.

22. The system of claim 1, wherein the electronic data listing the at least one recent payment made using the physical value transfer card includes at least one recent payment detected as being associated with potentially fraudulent activity and at least one recent payment not detected as being associated with potentially fraudulent activity.

23. The system of claim 22, wherein the at least one recent payment detected as being associated with potentially fraudulent activity and the at least one recent payment not detected as being associated with potentially fraudulent activity are payments made on a same day.

24. The method of claim 11, wherein detecting potentially fraudulent activity associated with the physical transfer card based on the at least one recent payment made using the physical value transfer card includes at least one of:
determining that an amount spent at a particular vendor or website is greater than a threshold;
identifying abnormal spending patterns;
determining that a distance between two or more recent payments is greater than a threshold; or
determining that the physical transfer card was used at a location known to be high risk.

25. The method of claim 11, wherein the electronic data listing the at least one recent payment made using the physical value transfer card includes at least one recent payment detected as being associated with potentially fraudulent activity and at least one recent payment not detected as being associated with potentially fraudulent activity.

26. The method of claim 25, wherein the at least one recent payment detected as being associated with potentially fraudulent activity and the at least one recent payment not detected as being associated with potentially fraudulent activity are payments made on a same day.
